(19) United States
(12) Patent Application Publication
(10) Pub. No.: US 2016/0033308 A1
(43) Pub. Date: Feb. 4, 2016

(54) INTELLIGENT GAUGE DEVICES AND RELATED SYSTEMS AND METHODS

(71) Applicant: INFINEON TECHNOLOGIES AG, NEUBIBERG (DE)

(72) Inventors: MARTIN WIESSFLECKER, Graz (AT); GERALD HOLWEG, Graz (AT); WALTHER PACHLER, Graz (AT); WERNER KOELE, Lieboch (AT)

(21) Appl. No.: 14/450,845

(22) Filed: Aug. 4, 2014

(51) Int. Cl. G01D 7/00; H04W 4/00

(52) U.S. Cl. CPC G01D 7/00; H04W 4/005; H04W 4/008

(57) ABSTRACT

Embodiments relate to intelligent sensing devices, systems, and methods for the measurement of a wide variety of parameters. In embodiments, an intelligent sensing device includes at least one sensor configured to measure a characteristic proximate the sensing device as a data parameter, an integrated circuit electrically coupled to the at least one sensor, the integrated circuit comprising memory and configured to store the data parameter in the memory, and an antenna electrically coupled to the integrated circuit and configured to transmit the data parameter stored in the memory to a remote device.

### TECHNICAL FIELD

Embodiments relate generally to miniaturized sensor components, and more particularly, to devices, systems, and methods for the measurement of parameters by miniaturized sensor components and the contactless transmission of measured parameters therefrom.

### BACKGROUND

Parameter measurement is important in numerous fields, such as packaging, medical device, human or pet health monitoring, home automation, food storage, and so on. Parameters can include biological, chemical, electrical, electrochemical, or any other appropriate parameter, such as temperature, humidity, or chemical changes for food safety, among others. For example, in one particular health monitoring related example, certain diabetes blood sugar meters measure the amount of glucose in the blood of a user. Other monitors can determine the amount of lactate in a user's body, for example. Traditionally, parameter measurement and analysis such as those described requires a wired or plugged-in connection from the sensor to the evaluating device, thus leading to additional complexity and difficulty of use.

Additionally, the measurement of certain aforementioned parameters in packaging such as bottles, ampoules, blister packs, and other packaging, is traditionally done with measuring strips or small sample containers that can only be evaluated with manual and inaccurate color codes or with the aid of dedicated measuring instruments. Using color codes or color strips to determine a change in color often leads to subjective inaccuracies in interpretation. Alternatively, while using dedicated measuring instruments can provide higher accuracy and often avoids subjective interpretation errors, such instruments have additional cost and additional maintenance and storage. Due to the nature of these and other applications, the sensors monitoring or measuring the aforementioned parameters should be small, safe, accurate, and often disposable, which has traditionally been a problem to engineer and manufacture.

### SUMMARY

Therefore, there is a need for small, cost-effective, accurate, and contactless sensing devices and systems that provide very simple mounting on different objects for detecting and transmitting biological, chemical, electrical, electrochemical, and other parameters.

In an embodiment, a sensing device comprises at least one sensor configured to sense a characteristic as a data parameter, an integrated circuit electrically coupled to the at least one sensor, the integrated circuit comprising memory and configured to store the data parameter in the memory, and an antenna electrically coupled to the integrated circuit, wherein the at least one sensor, the integrated circuit, and the antenna are integrated into a unitary body, and wherein the antenna is configured to transmit the data parameter stored in the memory to a remote device upon contactless placement of the remote device within a range of the antenna.

In an embodiment, an intelligent sensing device system comprises a sensing device configured to be operably coupleable to a packaging container and including at least one sensor configured to sense a characteristic as a data parameter, and an antenna configured to transmit the data parameter, and a remote device configured to receive the data parameter from the antenna, the remote device further comprising a graphical user interface adapted to display the received data parameter.

In an embodiment, a method of measuring at least a parameter comprises providing at least a sensing device configured to be operably coupleable to a packaging container, providing at least a sensor configured to sense at least a characteristic proximate the packaging container as a data parameter, providing a memory to store the data parameter in the sensing device, and providing an antenna configured to transmit the stored data parameter from the sensing device to a remote device upon contactless placement of the remote device proximate the sensing device.

### BRIEF DESCRIPTION OF THE DRAWINGS

The invention may be more completely understood in consideration of the following detailed description of various embodiments of the invention in connection with the accompanying drawings, in which:

FIG. 1 is a block diagram of an intelligent sensing device, according to an embodiment.

FIG. 2 is a block diagram of an intelligent sensing device, according to an embodiment.

FIG. 3 is a block diagram of a system utilizing an intelligent sensing device, according to an embodiment.

FIG. 4 is a graphical representation of a system utilizing an intelligent sensing device, according to an embodiment.

FIG. 5 is a graphical representation of a system utilizing an intelligent sensing device with a blister pack packaging, according to an embodiment.

FIG. 6A is a graphical representation of an intelligent sensing device configured for placement on or under skin, according to an embodiment.

FIG. 6B is a graphical representation of a system utilizing the intelligent sensing device of FIG. 6A, according to an embodiment.

FIG. 7 is a graphical representation of a system utilizing an intelligent sensing device with a bottle packaging, according to an embodiment.

FIG. 8A is a graphical representation of an intelligent sensing device, according to an embodiment.

FIG. 8B is a graphical representation of a system utilizing the intelligent sensing device of FIG. 8A, according to an embodiment.

FIG. 9 is a flowchart of a method utilizing an intelligent sensing device, according to an embodiment.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

Embodiments relate to intelligent sensing devices, systems, and methods for the measurement of a wide variety of parameters. In embodiments, “intelligent,” strip-type, and/or container-type, contactless disposable measuring elements have an integrated circuit for acquiring and transmitting sensor data in conjunction with at least one sensor for parameter measurement and an antenna for contactless data transmission to and optionally from a reading device, and optionally, energy transmission from a reading device such as a smartphone.

In embodiments, sensing devices are miniaturized or small in size or form factor in order to minimize any impact on sensing device placement or the mobility or functionality of the placed-on or in object. Sensing devices can be integrated seamlessly into existing behavior or living patterns such that sensing devices are easily applicable on various small, irregular, and/or resilient surfaces, in embodiments. Sensing devices can asynchronously or synchronously sense or monitor parameters and subsequently store and/or communicate the sensed parameters.

In embodiments, sensing devices can be evaluated or accessed contactlessly and wirelessly by a smartphone, tablet, PDA, or other suitable reading device. Therefore, sensing devices can be read or utilized with commonly available equipment. By placement of the reading device in the proximity of the sensing device, or vice-versa, data can be read and evaluated from the sensing device by the reading device, and/or data can be transmitted from the sensing device to the reading device. In embodiments, reading device software, such as mobile apps, can be utilized to further store, archive, evaluate, or compare the sensed data.

In embodiments, devices, systems, and methods can provide highly accurate measurement and evaluation without a dedicated instrument. In embodiments, the integration of intelligent, contactless sensors (sensor-based data acquisition and contactless data transmission, e.g. by radio-frequency identification (RFID) or near field communication (NFC)) in sample containers or measuring strips can be evaluated by smartphones, tablets or other reading devices with contactless functionality.

An intelligent measuring strip can also be embodied in or as a tablet blister pack. In such embodiments, a sensor device can be configured to measure the electrical resistance of a resistive line lead over all tablet positions, the resistance of which changes when tablets are removed from their respective blister pouches as a result of singular interruptions of the line, and whereby the number of tablets removed can be detected. Reliable manufacturer identification can also be determined in such embodiments. In still other embodiments, compliance information regarding dosage and/or timing can also be recorded by the sensor device.

In other embodiments, sensor devices can be integrated into containers such as bottles, boxes, cartons, ampoules, syringes, medical vials, IV bags, IV tubing, and other packaging. In embodiments, sensor devices can be integrated into similar packaging, such as business cards or credit cards. In other embodiments, sensor devices can be embedded or implanted in human or animal skin or bodies.

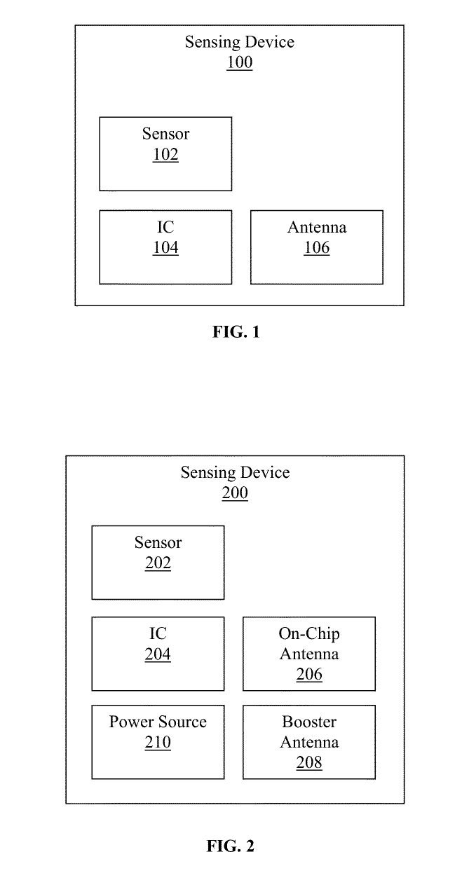

Referring to FIG. 1, a block diagram of a sensing device 100 is depicted, according to an embodiment. Sensing device 100 generally comprises a sensor 102, an integrated circuit (IC) 104, and an antenna 106.

Sensor 102 can comprise any suitable sensor such as an acoustic, vibration, speed, chemical, electric current, electric potential, magnetic, radio, environmental, moisture, humidity, flow, fluid velocity, radiation, navigational, positional, angle, displacement, distance, speed, acceleration, optical, light, imaging, pressure, force, density, level, thermal, temperature, proximity, presence, acoustic, audio, visual, video, infrared, or any other appropriate sensor. Therefore, sensor 102 is configured to sense, detect, monitor, or otherwise measure biological, chemical, electrical, electrochemical or other parameters adjacent to, surrounding, or coupled to sensor 102. In other embodiments, sensor 102 comprises a plurality of different types of sensors. For example, sensor 102 can comprise a sensor cluster of multiple types of sensors.

In embodiments, sensor 102 and/or entire sensing device 100 is easily mounted, fastened, or otherwise coupled in or on various very small, irregular and resilient surfaces. In embodiments, sensor 102 is miniaturized or small in size or form factor. In an embodiment, sensor 102 comprises a so-called sensor grain. Miniaturization of sensor 102 allows for the embedding or implanting of sensor 102 in certain objects, such as packaging or under skin.

Integrated circuit (IC) 104 is operably coupled to sensor 102. IC 104 is configured for acquiring data from sensor 102, and further for transmitting the acquired data via antenna 106. In an embodiment, IC 104 comprises a set of electronic circuits on a single chip. In other embodiments, IC 104 comprises sets of electronic circuits on multiple chips. Single or multiple chips can be arranged on one or more substrates, and optionally in one or more packages. In some embodiments, specific IC packaging is omitted in order to reduce the size of sensing device 100, with IC 104 and one or both of sensor 102 and antenna 106 sharing a common substrate and sensor package, such as a sensor grain package.

According to embodiments, IC 104 can comprise a microprocessor or core. A processor can be any suitable programmable device that accepts digital data as input, is configured to process the input according to instructions or algorithms, and provides results as outputs. In an embodiment, the processor can be a central processing unit (CPU) configured to carry out the instructions of a computer program. In other embodiments, the processor can be an Advanced RISC (Reduced Instruction Set Computing) Machine (ARM) processor or other embedded microprocessor. In embodiments, IC 104 can comprise an application-specific integrated circuit (ASIC). In other embodiments, the processor comprises a multi-processor cluster. The processor is therefore configured to perform at least basic selected arithmetical, logical, and input/output operations.

IC 104 can further comprise memory that comprises volatile or non-volatile memory as required by the coupled microprocessor or core to not only provide space to execute the instructions or algorithms, but to provide the space to store the instructions themselves. The memory can further comprise space to store data collected by sensor 102. In embodiments, volatile memory can include random access memory (RAM), dynamic random access memory (DRAM), or static random access memory (SRAM), for example. In embodiments, non-volatile memory can include read-only memory, flash memory, ferroelectric RAM, hard disk, floppy disk, magnetic tape, or optical disc storage, for example, in embodiments where IC 104 is in electrical communication with outside memory devices. The foregoing examples in no way limit the type of memory that can be used, as these embodiments are given only by way of example and are not intended to limit subject matter hereof. In other embodiments, the memory comprises a plurality of memory. For example, a first set of memory can be solely for use by the processor to store the instructions or algorithms, and a second set of memory can be solely for use in storing data collected by sensor 102.

As will be described further below, in embodiments, IC 104 can command sensor 102 to record sensor data. For example, IC 104 can command sensor 102 to record sensor data at a specified interval or timing. In other embodiments, IC 104 is passive such that IC 104 is configured to receive commands before executing or commanding other components. For example, IC 104 can receive a command to record sensor data, and in turn, direct or otherwise command sensor 102.

In embodiments, IC 104 and/or sensor 102 can further comprise additional sensor circuitry, such as noise cancelation circuitry, analog-to-digital (A/D) conversion circuitry, digital processing circuitry, and other circuitry.

Antenna 106 is operably coupled to sensor 102 and/or IC 104. In embodiments, antenna 106 is hardwired to sensor 102 and/or IC 104. In other embodiments, antenna 106 is not wired to sensor 102 and/or IC 104; instead, wireless communication is utilized to operably couple antenna 106 to sensor 102 and/or IC 104. Antenna 106 can further comprise a field concentrator device. In such embodiments, the field concentrator device comprises any conductive lines or antenna layers. In embodiments, antenna 106 is configured for contactless data transmission. In other embodiments, antenna 106 is configured for contact-based data transmission. Antenna 106 can comprise a NFC antenna, RFID antenna, WIFI antenna, ZigBee antenna, Bluetooth antenna or any other suitable data transmission antenna. Therefore, antenna 106 is configured to transmit the data sensed, detected, monitored, or otherwise measured by sensor 102 to a receiving device, as commanded or directed by IC 104, the receiving device, or some other device. In embodiments, antenna 106 comprises a UHF (dipole) antenna configured for several meters range. In other embodiments, antenna 106 comprises an HF (spiral) antenna configured for several centimeters or millimeters range. In embodiments, the antenna operates at a frequency such as 13.56 MHz, though this is but one example, and other frequencies and frequency ranges can be implemented in other embodiments

Referring to FIG. 2, a block diagram of a sensing device 200 is depicted, according to an embodiment. Sensing device 200 generally comprises a sensor 202, an integrated circuit (IC) 204, an on-chip antenna 206, a booster antenna 208, and a power source 210.

In embodiments, sensor 202 is substantially similar to sensor 102 discussed above. Likewise, IC 204 is substantially similar to IC 104 of sensor 202 discussed above. Further, on-chip antenna 206 is substantially similar to antenna 106 discussed above.

Booster antenna 208 is configured to extend the range of on-chip antenna 206. In embodiments, on-chip antenna 206 and booster antenna 208 can comprise the same discrete package. In other embodiments, as depicted in FIG. 2, booster antenna 208 comprises a separate discrete package. As such, booster antenna 208 can be operably coupled to any of the components of sensing device 200, as appropriate. Booster antenna 208 can comprise an antenna configured to transmit further or with a stronger signal than on-chip antenna 206. In embodiments, booster antenna 208 can comprise a NFC antenna, RFID antenna, WIFI antenna, ZigBee antenna, Bluetooth antenna, or any other suitable data transmission antenna.

In embodiments, booster antenna 208 is configured to transmit the data sensed, detected, monitored, or otherwise measured by sensor 202 to a receiving device external to sensing device 200, as commanded or directed by IC 204, the receiving device or some other device or factor. In such embodiments, booster antenna 208 handles data transmission, without integration with or interfacing to on-chip antenna 206. In other embodiments, booster antenna 208 is configured to receive data transmissions from on-chip antenna 206 and re-transmit the data further or with a stronger signal than on-chip antenna 206. In other embodiments, on-chip antenna 206 can be substituted for booster antenna 208 such that only booster antenna 208 is present within sensing device 200.

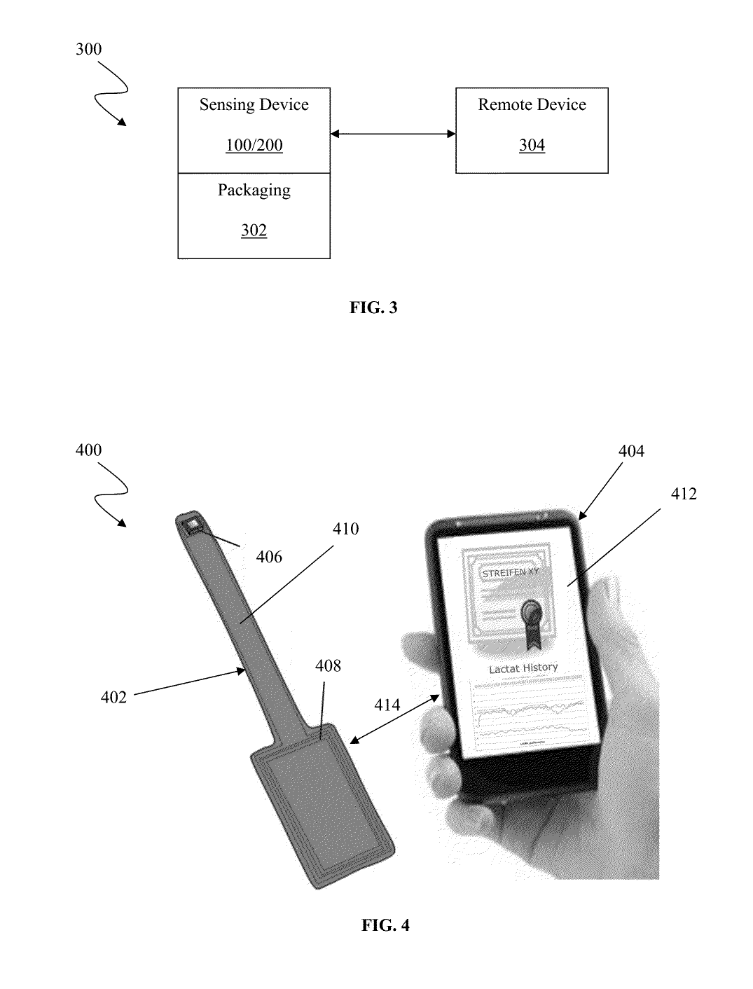

Power source 210 is configured to provide power to one or more of the components of sensing device 200, including sensor 202, IC 204, on-chip antenna 206, or booster antenna 208. In an embodiment, power source 210 comprises a battery, such as a lithium-ion (Li-ion or LIB) or other suitable battery. In embodiments, power source 210 is rechargeable. In embodiments, as will be discussed with respect to FIG. 3, power source 210 can be recharged by a reading device, such as a smartphone. In still other embodiments, power source 210 can comprise some other power source, such as an energy harvesting device (e.g., from physical movement, chemical reaction or other source), solar device, a wireless battery device, or another source of power to one or more components of sensing device 200. In embodiments, components of sensing device 200 can be placed in a sleep or stand-by mode and utilize power from power source 210 only at certain intervals or when needed. In other embodiments, power source 210 can be wired from a larger power supply.

In embodiments, any of the components of sensing device 100 or sensing device 200 can be substituted, combined, or removed as will be readily understood by one skilled in the art. For example, referring again to FIG. 1, sensor 102 and IC 104 can be combined and integrated into or on a single discrete part, substrate or chip, in embodiments. Likewise, referring to FIG. 2, sensor 202 and IC 204 can be combined and integrated into or on a single discrete part, substrate or chip, in embodiments. In other embodiments, equivalent components can be utilized for any of the components of sensing device 100 or sensing device 200. In other embodiments, additional components can be included in sensing device, such as a clock, timer, input/output hardware, ASICs, or any other suitable components.

Referring to FIG. 3, a block diagram of a system 300 utilizing an intelligent sensing device is depicted, according to an embodiment. System 300 generally comprises a sensing device, packaging 302 and remote device 304.

In embodiments, system 300 comprises a sensing device such as sensing device 100 or sensing device 200 as described above. In other embodiments, other sensing devices can be utilized with system 300, as will be readily understood by one skilled in the art.

Sensing device 100/200 can be operably coupled to or in packaging 302. In embodiments, packaging 302 can comprise physical packaging such as a bottle, bag, box, food or beverage container, ampoule, blister pack, clothing, or other suitable packaging. In other embodiments, packaging 302 refers to skin, such as human or animal skin or tissue. In embodiments, the operable coupling of sensing device 100/200 to packaging 302 can comprise an adhesive coupling, an insertion of sensing device 100/200 into or on packaging 302, such as within a container or embedding under the skin, a sewing of sensing device 100/200 to packaging 302, or any other suitable coupling. In embodiments, sensing device 100/200 is manufactured integrally with or integral to packaging 302.

Remote device 304 (or otherwise referred to as a reading device) is configured to be communicatively coupled with sensing device 100/200. In embodiments, remote device 304 comprises a smartphone, a tablet, a personal digital assistant (PDA), laptop computer, watch, or other suitable remote device. As such, in embodiments, remote device 304 further comprises a processor, memory, and a graphical user interface (GUI). The processor of remote device 304 can be any suitable programmable device that accepts digital data as input, is configured to process the input according to instructions or algorithms, and provides results as outputs. Digital data, the instructions or algorithms, or other intermediary instructions or data can be stored in the memory of remote device 304. Outputs from the processor can be provided on the GUI.

In embodiments, remote device 304, like sensing device 100/200, is configured for contactless data transmission. In other embodiments, sensing device 100/200 is configured for contact-based data transmission. Remote device 304 can comprise NFC hardware, RFID hardware, WIFI hardware, ZigBee hardware, BLUETOOTH hardware, or any other suitable data transmission hardware. In contact-based embodiments, remote device 304 can comprise wired hardware, such as USB, FIREWIRE, PS/2, EEPROM, or any other suitable wired connection and appropriate connectors. In embodiments, as part of, or in addition to data transmission, remote device 304 can be configured to recharge any battery on sensing device, such as power source 210 of sensing device 200. In embodiments, recharging of power source 210 can be wireless or with a wired connection.

In other embodiments, remote device 304 comprises a plurality of devices. For example, remote device 304 can comprise a secondary device that adapts to or communicates with a smartphone, a tablet, a personal digital assistant (PDA), laptop computer, watch, or other suitable remote device. In such embodiments, the functionality or hardware of remote device 304 described above as part of a discrete single device can be split among the plurality of devices.

Referring to FIG. 4, a graphical representation of a system 400 utilizing an intelligent sensing device is depicted, according to an embodiment. System 400 generally comprises sensing device 402 and remote device 404. The components of system 400 and other figures depicted herein are not necessarily to scale, used for discussion and illustration purposes without limitation.

In an embodiment, sensing device 402 comprises a combined sensor and integrated circuit 406 (sensor/IC 406), an antenna 408, and a body 410. In embodiments, sensor/IC 406 is substantially similar to the sensors and integrated circuits described above with respect to FIGS. 1-2. Likewise, antenna 408 is substantially similar to the antennas described above with respect to FIGS. 1-2. In the embodiment depicted, antenna 408 is configured for wireless data and energy transmission. Body 410 provides a structure for housing or supporting sensor/IC 406 and antenna 408. In an embodiment, body 410 comprises a common substrate for housing the aforementioned components. In an embodiment, body 410 comprises a unitary body. In other embodiments, as will be readily understood, body 410 comprises a unitary package, wrap, coating, paper, fabric, film, foil, sheet, web, or other appropriate material.

As depicted, sensor/IC 406 is positioned at one end of body 410, and antenna 408 is positioned at an opposite end. In other embodiments, body 410 is instead more compact or has some other shape or configuration. In some embodiments, the configuration of body 410 can be determined by a configuration of antenna 408, while in other embodiments it can be determined by some other factor(s), such as an application of sensor/IC 406, a desired design or aesthetic, a marketing effort, a product design or demand, a regulatory factor or consideration, or some other factor(s). In an embodiment, sensor/IC 406 is not directly wired to antenna 408 along body 410, but instead utilizes wireless coupling.

Remote device 404 is substantially similar to remote device 304, in embodiments. As depicted, remote device 404 is a smartphone having a wireless communication interface and a graphical user interface 412. For example, graphical user interface (GUI) 412 can display data sensed or monitored by sensing device 402. As illustrated, a lactate measurement in, for example, blood or saliva, is displayed by GUI 412, as sensed and recorded by sensing device 402. Remote device 404 can be configured to download or otherwise obtain an app or other software for interfacing with sensing device 402, and the app or other software can enable GUI 412, communication with sensing device 402, and other functions and elements of system 400.

Sensing device 402 and remote device 404 are configured to communicate along communication channel 414. Communication channel 414 generally comprises a wireless data channel, such as NFC, RFID, WIFI, ZigBee, Bluetooth, or any other suitable channel. In embodiments, such wireless communication occurs when remote device 304 is placed in relative proximity to sensing device, and more particularly, to antenna 408. In other embodiments, communication along communication channel 414 occurs even when remote device 404 is distal from sensing device 402. In other embodiments, communication channel 414 further comprises a booster or transfer device, such as a signal booster, router, network switch, or modem. Communication along communication channel 414 can be automatic or manually initiated. For example, it can be triggered by remote device 404 and sensing device 402 being within a particular proximity of one another, a timer, a user manually requesting data, or some automatic or manual trigger.

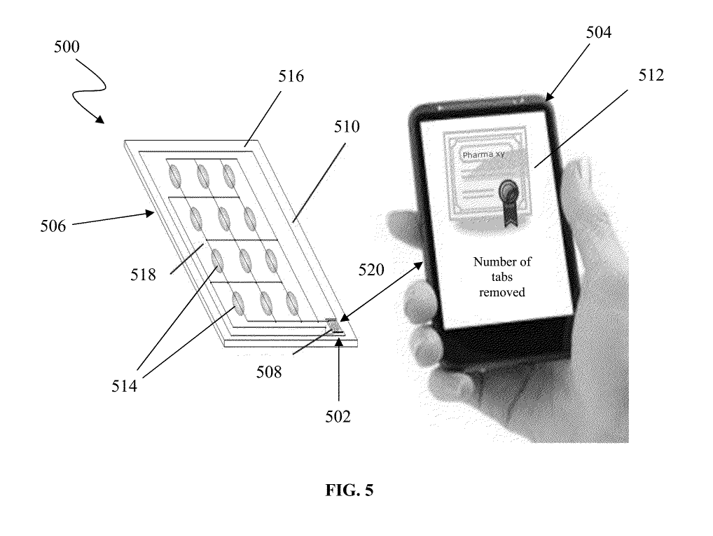

Referring to FIG. 5, a graphical representation of a system 500 utilizing an intelligent sensing device is depicted, according to an embodiment. System 500 generally comprises sensing device 502, remote device 504, and packaging 506.

Sensing device 502, in an embodiment, is substantially similar to any of the aforementioned sensing devices. In an embodiment, sensing device 502 comprises a combined sensor and integrated circuit 508 (sensor/IC 508) and an antenna 510. In embodiments, sensor/IC 508 is substantially similar to the sensors and integrated circuits described above. In the embodiment depicted, the sensor portion of sensor/IC 508 comprises an impedance sensor. In embodiments, the sensor portion of sensor/IC 508 comprises an ohmic measurement log sensor. Further, antenna 510 is substantially similar to the antennas described above. In the embodiment depicted, antenna 510 is configured for wireless data transmission.

Remote device 504, in an embodiment, is substantially similar to any of the aforementioned remote devices, such as remote device 404. As depicted, remote device 504 is a smartphone having a wireless communication interface and a graphical user interface 512. For example, graphical user interface 512 can display data sensed or monitored by sensing device 502. As illustrated, a number of tabs removed from packaging 506 is displayed by GUI 512, as sensed and recorded by sensing device 502, as will be discussed. In still other embodiments, other information related to packaging 506 can be obtained and/or displayed, such as a number of tabs remaining, a timing of tab removal, a number of tabs removed within a particular period of time, an expiry of tab effectiveness, or other timing, dosage, or other information related to packaging 506 and/or its contents or interaction with a user.

Packaging 506, in an embodiment, comprises packaging housing 516, tab apertures 514, and resistive lines 518. As depicted, packaging 506 is a blister pack. Packaging housing 516 comprises a body for housing the contents of material packaged within or coupled with packaging 506. Further, packaging housing 516 is configured to support sensing device 502.

A plurality of tab apertures 514 are positioned within packaging housing 516. As shown, tab apertures 514 are spaced uniformly within packaging housing 516. In other embodiments, tab apertures 514 can be spaced inconsistently within packaging housing 516. In other embodiments, packaging 506 comprises a single tab aperture 514.

Resistive lines 518 are positioned adjacent to, in contact with, or otherwise coupled to the plurality of tab apertures 514. In embodiments, not all tab apertures are in contact with a resistive line 518. Resistive lines 518 are positioned to detect the breaking or removal of a given tab (such as a pill) from its tab aperture 514. Resistive lines 518 are further in electrical communication (wired or wireless) with sensor/IC 508.

Sensing device 502 and remote device 504 are configured to communicate along communication channel 520. In embodiments, communication channel 520 is substantially similar to communication channel 414 described above with respect to FIG. 4.

Referring still to FIG. 5, in operation, once a tab is broken or otherwise released from a tab aperture 514, resistive lines 518 relay this activity through electrical communication to the impedance sensor of sensor/IC 508. Sensor/IC 508 can record or otherwise store this data in memory. When appropriate, for example, when remote device 504 is placed proximate sensor/IC 508, the stored data can be transferred to remote device 504 along communication channel 520. Remote device 504 can be further configured to analyze or evaluate the transferred data. Finally, as depicted, remote device can display the number of tabs removed from packaging 506 through GUI 512.

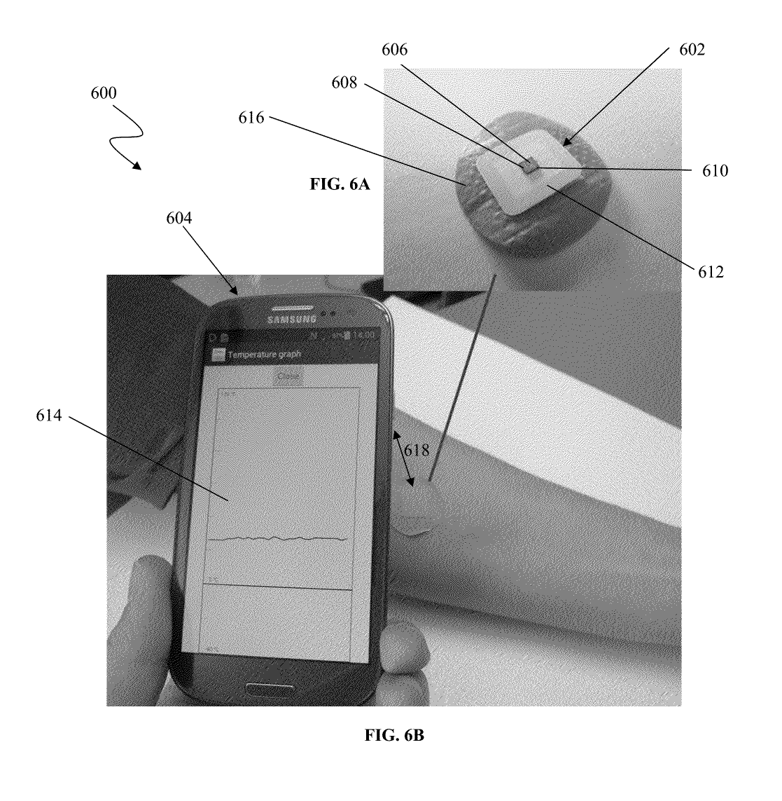

Referring to FIGS. 6A-6B, a graphical representation of a system 600 utilizing an intelligent sensing device is depicted, according to an embodiment. Referring specifically to FIG. 6A, a graphical representation of an intelligent sensing device 602 configured for placement on or under skin is depicted, according to an embodiment. Referring to FIG. 6B, sensing device 602 can be utilized within intelligent sensing system 600 with, for example, remote device 604.

Sensing device 602, in an embodiment, is substantially similar to any of the aforementioned sensing devices. In an embodiment, sensing device 602 comprises an integrated circuit (not visible), a temperature sensor 606, a humidity sensor 608, an on-chip antenna 610, and a booster antenna 612.

Temperature sensor 606 can comprise a sensor configured to measure contacted or proximate temperature that is integrated into the integrated circuit. In other embodiments, temperature sensor 606 is a discrete component separate from the integrated circuit. Humidity sensor 608 can comprise a sensor configured to measure contacted or proximate humidity that is integrated into the integrated circuit. In other embodiments, humidity sensor 608 is a discrete component separate from the integrated circuit. According to embodiments, skin humidity monitoring by humidity sensor 608 comprises on-chip electrodes for impedance spectroscopy.

In other embodiments, sensing device 602 can comprise additional or other sensors, such as acceleration, glucose, acoustic and other sensor types.

On-chip antenna 610 is substantially similar to antenna 102 or antenna 206 as described above and is configured for contact-less data transmission.

Booster antenna 612 is substantially similar to booster antenna 208 as described above and is configured to extend the transmission range of on-chip antenna 610.

Further, in embodiments, sensing device 602 can further comprise an on-chip battery, such as a lithium-ion battery (not visible).

Sensing device 602 further comprises packaging 616. In the embodiment depicted in FIGS. 6A-6B, packaging 616 comprises an adhesive cover that at least surrounds the largest component or body or sensing device 602. Packaging 616 is configured to adhesively secure to the skin of a user such that the exposed sensors, such as temperature sensor 606 and humidity sensor 608 are positioned proximate the skin. Other types of packaging 616 can be used in other embodiments, including adhesive tape, wraps, bands and the like. In still other embodiments, packaging 616 can be a package of sensing device 602 itself or an intermediate device such as a tab or backing, which is later combined with one or more other devices to affix sensing device 602 to a user. In other words, the adhesive bandage-type device of FIG. 6A can be separate from packaging 616 of sensing device 602 in embodiments, and used to secure packaging 616 of sensing device 602 to a user, animal or other object.

Remote device 604 in an embodiment is substantially similar to any of the aforementioned remote devices. As depicted, remote device 604 is a smartphone or tablet having a wireless communication interface and a graphical user interface 614. For example, graphical user interface 614 can display data sensed or monitored by sensing device 602. As illustrated, a temperature graph is displayed by GUI 614, as sensed and recorded by sensing device 602, as will be described.

Sensing device 602 and remote device 604 are configured to communicate along communication channel 618. In embodiments, communication channel 618 is substantially similar to any of the aforementioned communication channels.

Referring still to FIGS. 6A-6B, in operation, sensing device 602 is adhered, affixed, or otherwise secured to the skin of a user. In other embodiments (not shown), sensing device 602 is affixed to an animal or other appropriate object. Once affixed, sensing device 602 can utilize temperature sensor 606 and/or humidity sensor 608 to determine appropriate parameters of the skin or proximate the skin. The integrated circuit can record or otherwise store this data in memory. When appropriate, for example, when remote device 604 is placed proximate on-chip antenna 610 and/or booster antenna 612, the stored data can be transferred to remote device 604 along communication channel 618. Remote device 604 can be further configured to analyze or evaluate the transferred data. Finally, as depicted, remote device 604 can display a graph of temperature data through GUI 614. In other embodiments, particular temperature samples can be individually displayed. Likewise, while not shown, humidity data can be displayed through GUI 614.

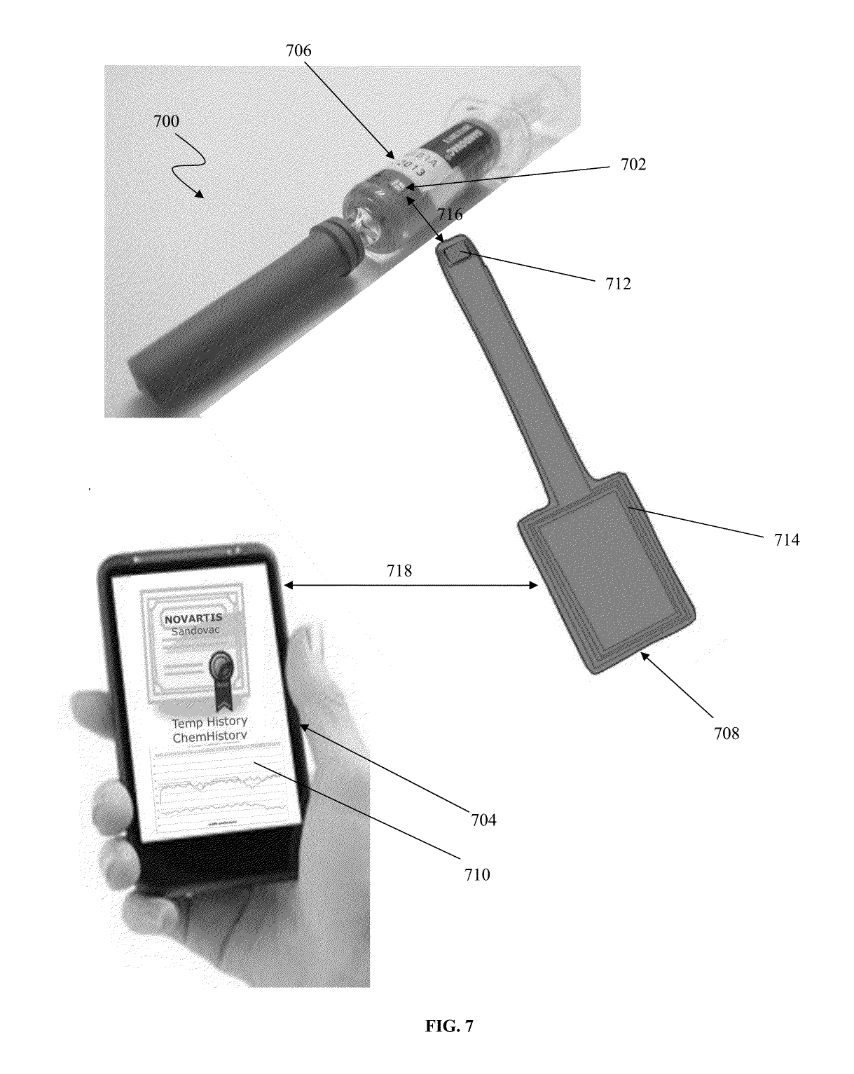

Referring to FIG. 7, a graphical representation of a system 700 utilizing an intelligent sensing device with a bottle packaging is depicted, according to an embodiment. System 700 generally comprises sensing device 702, remote device 704, packaging 706, and mobile booster antenna 708.

Sensing device 702, in an embodiment, is substantially similar to any of the aforementioned sensing devices. In embodiments, for example, sensing device 702 can comprise an integrated circuit, a temperature sensor, an electrochemical sensor, and an antenna. In embodiments, sensing device 702 can further comprise any of the components of other aforementioned sensing devices.

Remote device 704 in an embodiment is substantially similar to any of the aforementioned remote devices. As depicted, remote device 704 is a smartphone having a wireless communication interface and a graphical user interface 710. For example, graphical user interface 710 can display data sensed or monitored by sensing device 702. As illustrated, a temperature history graph and a chemical history graph is displayed by GUI 710, as sensed and recorded by sensing device 702.

Packaging 706, as depicted, comprises a bottle or syringe. In other embodiments, packaging 706 comprises any other suitable container for storing solid, liquid, or gas. In embodiments, sensing device 702 or components of sensing device 702 are positioned adjacent packaging 706 such that sensing device 702 or components of sensing device 702 are in contact with the contents of packaging 706. In other embodiments, sensing device 702 or components of sensing device 702 are positioned distal the walls of packaging 706. Depending on the sensor or sensors utilized or the accuracy or frequency of measurement desired, sensing device 702 can be positioned in myriad configurations along or within packaging 706.

Mobile booster 708 comprises a field concentrator 712 and a transmission antenna 714. In embodiments, field concentrator device 712 can comprise any conductive lines or antenna layers. In embodiments, transmission antenna 714 is configured for contactless data transmission. In other embodiments, transmission antenna 714 is configured for contact-based data transmission.

Sensing device 702 and mobile booster 708 are configured to communicate along communication channel 716. In embodiments, communication channel 716 is substantially similar to any of the aforementioned communication channels. Mobile booster 708 is configured to communicate with remote device 704 along communication channel 718. Likewise, in embodiments, communication channel 716 is substantially similar to any of the aforementioned communication channels.

As such, in embodiments of system 700, there are three antennas. Sensing device 702 comprises a first antenna; mobile booster 708 comprises a second antenna; and the integrated circuit 704 comprises a third antenna. Between the three antennas there is no galvanic/electric connection. The antenna in sensing device 702 can be electrically connected to an amplifier and receiver. As to the integrated circuit and the third antenna, this third antenna is electrically connected to the circuitry on the chip which includes a receiver and transmitter. In embodiments, as will be readily understood, remote device 704 can comprise a fourth antenna in communication with mobile booster 708 and the second antenna.

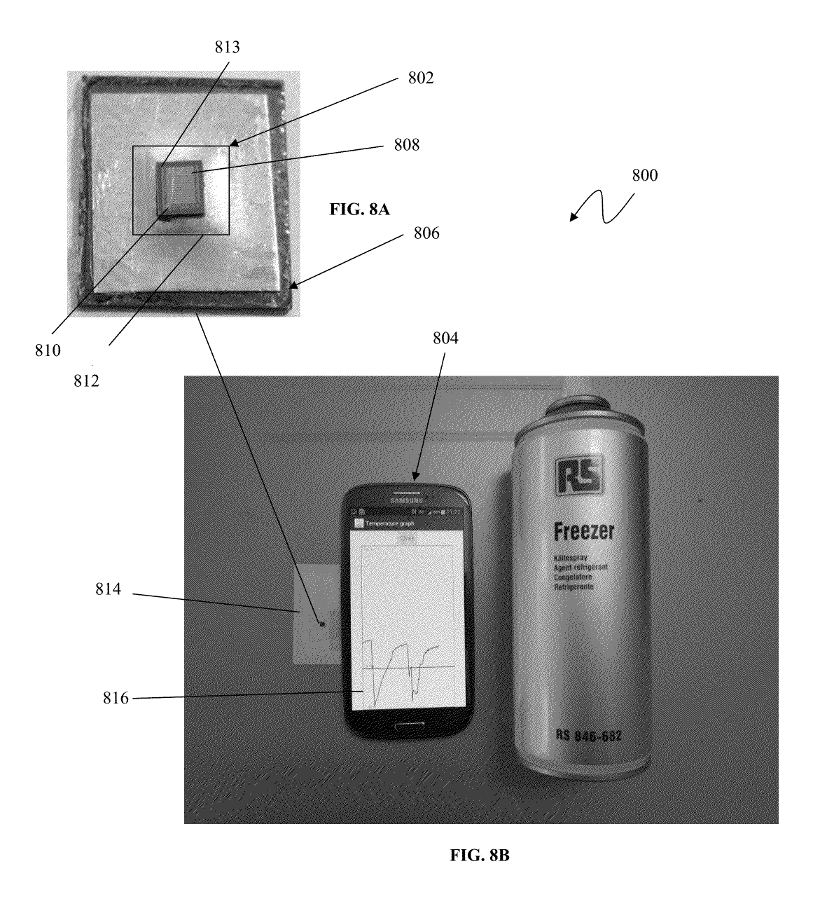

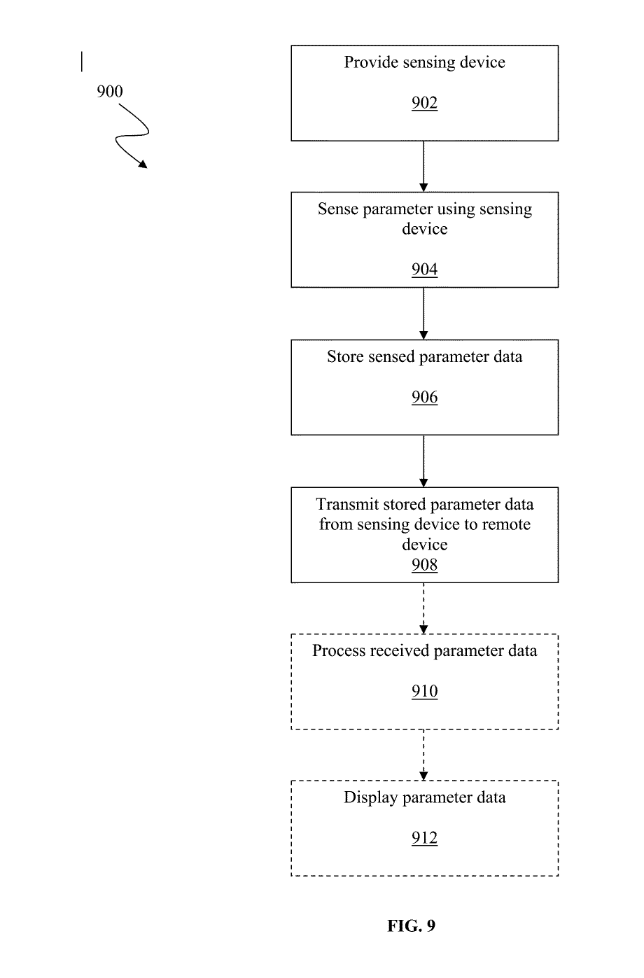

Referring collectively to FIGS. 8A and 8B, a system 800 utilizing an intelligent sensing device with a packaging is depicted, according to an embodiment. System 800 generally comprises sensing device 802, remote device 804, and packaging 806.

Referring specifically to FIG. 8A, a graphical representation of sensing device 802 is depicted, according to an embodiment. Sensing device 802, in an embodiment, is substantially similar to any of the aforementioned sensing devices. For example, in an embodiment, sensing device 802 comprises an integrated circuit 808, a temperature sensor 810, a battery 812, an on-chip antenna 813, and a booster antenna 814. In an embodiment, integrated circuit 808 and/or components thereof comprises a single chip, or autonomous sense and identification grain (ASIG).

Referring specifically to FIG. 8B, remote device 804, in an embodiment, is substantially similar to any of the aforementioned remote devices. As depicted, remote device 804 is a smartphone having a wireless communication interface and a graphical user interface 808. For example, graphical user interface 808 can display data sensed or monitored by sensing device 802. As illustrated, a temperature history graph is displayed by GUI 808, as sensed and recorded by sensing device 802.

As depicted in both FIGS. 8A and 8B, sensing device 802 is operably coupled to packaging 806. For example, as depicted, battery 812 is at least partially embedded within packaging 806. In an embodiment, battery 812 is a lithium ion micro battery. In embodiments, integrated circuit 808 is positioned to protrude outside of packaging 806. In other embodiments, all components of sensing device 802 are at least partially embedded within packaging 806. In still other embodiments, all components of sensing device 802 are operably coupled to the outside of packaging 806. In an embodiment, packaging 806 generally comprises a square and has an edge 9 mm in length. Battery 812 comprises a square having an edge 4 mm in length. Integrated circuit 808 comprises a square having an edge 2.3 mm in length. In other embodiments, other shapes and sizes are considered.

In embodiments, packaging 806 forms part of a can, bottle or container, such as the one depicted in FIG. 8B. In still other embodiments, packaging 806 is coupled to or arranged within or on the can, bottle or other container.

In another embodiment of a system, color strips associated with a packaging can be utilized in combination with a remote device having a camera. In such embodiments, color strips can effectively “sense” a parameter associated with the packaging by the turning or changing of a color. The remote device, and in particular, the camera of the remote device, can image, record, or otherwise document the color strip. Subsequent processing or display can be done on the recorded image or images, as described above with respect to other embodiments, in order to evaluate the packaging or contents of the packaging.

In operation, referring to FIG. 9, a flowchart of a method 900 utilizing an intelligent sensing device is depicted, according to an embodiment.

At 902, a sensing device is provided. In embodiments, the sensing device is substantially similar to any of the aforementioned sensing device. The sensing device can comprise one or more sensors. In embodiments, at 902, the sensing device is operably coupled to appropriate packaging. In other embodiments, the sensing device is machined, formed, or otherwise provided integral to the packaging. In embodiments, the sensing device can be placed, positioned, or manufactured prior to the contents of the packaging being placed within the packaging. In other embodiments, the sensing device can be placed, positioned, or manufactured after the contents of the packaging are placed within the packaging.

At 904, one or more parameters can be sensed or measured by the sensing device. In embodiments, the sensing device can be programmed to measure at preset or programmed intervals. In other embodiments, the sensing device is commanded to measure, such as by relative proximate placement of a remote device or reading device. In other embodiments, the sensing device is activated to measure upon movement, light, temperature, timing or any other suitable activation technique. In embodiments, the step of measuring or sensing one or more parameters at 904 can be repeated, iterated, or recursively executed. In embodiments, a single sensor can be activated at 904. In other embodiments of the sensing device having multiple sensors, multiple sensors can be activated at 904. In embodiments of the sensing device having multiple sensors, fewer than all of the sensors can be activated at 904. For example, in a sensing device having both a temperature sensor and a chemical sensor, both the temperature sensor and the chemical sensor can be activated at every sensing command or sensing event. In embodiments, the temperature sensor is activated at every sensing command or sensing event, but the chemical sensor is activated only at every other sensing command or sensing event. As will be readily understood, variations of sensing frequency or sensor occurrence can be implemented, according to the application or requirements of the system.

At 906, after the one or more parameters are sensed or measured by the sensing device, the sensed parameter data can be stored by the sensing device. In embodiments, the sensed parameter data can be stored in volatile or non-volatile memory integrated with the integrated circuit of the sensing device. In other embodiments, the sensed parameter data can be stored remotely from the sensing device.

At 908, the stored parameter data is transmitted from the sensing device to a remote device or reading device. In embodiments, the stored parameter data is transmitted automatically and wirelessly at a given interval to a distal remote device. In other embodiments, the stored parameter data is transmitted when the remote device is placed proximate the sensing device. In those embodiments, the respective antennas are placed in electrical communication with each other. In still other embodiments, the stored parameter data is transmitted from the sensing device upon physical contact with the remote device.

Optionally, at 910, the parameter data can be processed or analyzed. In embodiments, processing or analyzing the parameter data comprises summing, averaging, or otherwise evaluating the data. In embodiments, filtering, post-processing, transformation algorithms, or any other suitable data processing technique can be utilized. For example, parameter data can be dated, catalogued, and compared with historical data. In embodiments, trends or patterns can be derived.

Optionally, at 912, the parameter data can be displayed on the remote device, the reading device, or any other appropriate device. For example, as described above with respect to the remote devices including a GUI, the parameter data can be displayed graphically or textually on the GUI. In embodiments, the raw (non-processed or non-analyzed) parameter data can be displayed. In other embodiments, the processed parameter data can be displayed. Graphs, charts, summary tables, or any suitable data aggregation can be displayed. Alternatively, the raw data points can be displayed.

In a feature and advantage of embodiments, miniaturized intelligent sensing devices can be integrated in skin, packaging, or other containers that are difficult for traditional sensors to be integrated or coupled. Likewise, sensing devices can be operated without wired connections outside of the packaging, skin, or container.

In another feature and advantage of embodiments, intelligent sensing devices are simple and inexpensive to manufacture, yet are reliable. In a related feature and advantage of embodiments, intelligent sensing devices are disposable.

In another feature and advantage of embodiments, intelligent sensing devices can be used as part of systems that include existing (and future) wireless devices. Integration with widespread wireless devices allows for adaptable systems such that reading from sensing devices with a superfluous or third device is no longer needed.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A sensing device comprising:
at least one sensor configured to sense a characteristic as a data parameter;
an integrated circuit electrically coupled to the at least one sensor, the integrated circuit comprising memory and configured to store the data parameter in the memory; and
an antenna electrically coupled to the integrated circuit,
wherein the at least one sensor, the integrated circuit, and the antenna are integrated into a unitary body, and wherein the antenna is configured to transmit the data parameter stored in the memory to a remote device upon contactless placement of the remote device within a range of the antenna.

2. The intelligent sensing device of claim 1, further comprising:
a power source operably coupled to and configured to provide power to at least one of the at least one sensor, the integrated circuit, or the antenna.

3. The intelligent sensing device of claim 1, further comprising:
a booster antenna electrically isolated from the integrated circuit and configured to transmit the data parameter stored in the memory to a remote device at an extended operating range.

4. The intelligent sensing device of claim 3, wherein the integrated circuit and the booster antenna are electrically coupled by wireless communication.

5. The intelligent sensing device of claim 1, wherein the antenna is electrically coupled to the integrated circuit through an electrical connection.

6. The intelligent sensing device of claim 1, wherein the body is formed integral to a packaging container.

7. The intelligent sensing device of claim 1, wherein the at least one sensor is at least one of an acoustic, a vibration, a speed, a chemical, an electric current, an electric potential, a magnetic, radio, an environmental, a moisture, a humidity, a flow, a fluid velocity, a radiation, a navigational, a positional, an angle, a displacement, a distance, a speed, an acceleration, an optical, a light, an imaging, a pressure, a force, a density, a level, a thermal, a temperature, a proximity, a presence, an acoustic, or an audio sensor.

8. The intelligent sensing device of claim 1, wherein the antenna comprises at least one of a radio-frequency identification (RFID) antenna, near field communication (NFC) antenna, WI-FI antenna, ZigBee antenna, or Bluetooth antenna.

9. The intelligent sensing device of claim 1, wherein the at least one sensor and the integrated circuit are situated on a single chip.

10. An intelligent sensing device system comprising:
a sensing device configured to be operably coupleable to a packaging container and including
at least one sensor configured to sense a characteristic as a data parameter, and
an antenna configured to transmit the data parameter; and
a remote device configured to receive the data parameter from the antenna, the remote device further comprising a graphical user interface adapted to display the received data parameter.

11. The intelligent sensing device system of claim 10, wherein the antenna is configured to transmit the data parameter to the remote device upon contactless placement of the remote device proximate the sensing device.

12. The intelligent sensing device system of claim 10, wherein the packaging container is a blister pack including a plurality of tab apertures and a plurality of resistive lines operably coupled to each of the plurality of tab apertures, wherein the at least one sensor is configured to measure a breaking of one of the resistive lines.

13. The intelligent sensing device system of claim 10, wherein the packaging container is at least one of a bottle, a box, a carton, an ampoule, a syringe, a medical vial, an IV bag, an IV tubing, a business card, a credit card, or skin.

14. The intelligent sensing device system of claim 10, further comprising a wireless communication channel implemented by at least one of a near field communication (NFC) protocol, a radio-frequency identification (RFID) protocol, a WI-FI protocol, a ZigBee protocol, or a Bluetooth protocol.

15. The intelligent sensing device system of claim 10, wherein the remote device is further configured to process the received parameter data and display the processed parameter data on the graphical user interface.

16. A method of measuring at least a parameter, the method comprising:
providing at least a sensing device configured to be operably coupleable to a packaging container;
providing at least a sensor configured to sense at least a characteristic proximate the packaging container as a data parameter;
providing a memory to store the data parameter in the sensing device; and
providing an antenna configured to transmit the stored data parameter from the sensing device to a remote device upon contactless placement of the remote device proximate the sensing device.

17. The method of claim 16, further comprising displaying the data parameter on the remote device.

18. The method of claim 16, further comprising processing the data parameter on the remote device.

19. The method of claim 16, wherein providing at least a sensor configured to sense at least a characteristic proximate the packaging container as a data parameter comprises providing at least one of an acoustic, a vibration, a speed, a chemical, an electric current, an electric potential, a magnetic, radio, an environmental, a moisture, a humidity, a flow, a fluid velocity, a radiation, a navigational, a positional, an angle, a displacement, a distance, a speed, an acceleration, an optical, a light, an imaging, a pressure, a force, a density, a level, a thermal, a temperature, a proximity, a presence, an acoustic, or an audio sensor.

20. The method of claim 16, wherein providing at least a sensor comprises providing a plurality of sensors configured to sense a plurality of characteristics proximate the packaging container as a plurality of data parameters, and wherein a change to any of the plurality of data parameters indicates a contamination of the packaging container.

21. The method of claim 16, providing an antenna configured to transmit the stored data parameter from the sensing device to a remote device comprises further comprises accessing, with the antenna, a wireless communication channel implemented by at least one of a near field communication (NFC) protocol, a radio-frequency identification (RFID) protocol, a WI-FI protocol, a ZigBee protocol, or a Bluetooth protocol.
